(19) United States
(12) Patent Application Publication
(10) Pub. No.: US 2025/0154915 A1
(43) Pub. Date: May 15, 2025

(54) APPARATUS AND METHOD FOR CARRYING OUT A REGENERATION PROCESS OF A PARTICULATE FILTER OF A MOTOR VEHICLE, A MOTOR VEHICLE, AND A COMPUTER PROGRAM

(71) Applicants: HYUNDAI MOTOR COMPANY, Seoul (KR); KIA CORPORATION, Seoul (KR)

(72) Inventors: Christian Clemenz, Pfungstadt (DE); Stefan Lang, Graevenwiesbach (DE); Ondrej Galuszka, Wiesbaden (DE); Paul Kachisi, Frankfurt am Main (DE); Harald Mueller, Büttelborn (DE); Carlos Mazzetti, Idstein (DE)

(73) Assignees: HYUNDAI MOTOR COMPANY, Seoul (KR); KIA CORPORATION, Seoul (KR)

(21) Appl. No.: 18/651,169

(22) Filed: Apr. 30, 2024

(30) Foreign Application Priority Data
Nov. 9, 2023 (DE) 102023131088.7

(51) Int. Cl. F02D 41/02; B60W 10/06; B60W 10/08; B60W 20/16; B60W 30/14; F01N 11/00

(52) U.S. Cl. CPC F02D 41/029; B60W 10/06; B60W 10/08; B60W 20/16; B60W 30/143; F01N 11/002; B60W 2510/068; B60W 2540/10; B60W 2710/0644; F01N 2550/04

(57) ABSTRACT

An apparatus and a method are provided for carrying out a regeneration process of a particulate filter of a motor vehicle. The apparatus includes control circuitry configured to control decoupling, in the regeneration process, of an internal combustion engine from an output of a powertrain of the motor vehicle. Further, the control circuitry is configured to control providing, at least partly timely overlapping with the decoupling of the internal combustion engine, vehicle propulsion by at least one electric machine of the motor vehicle. The control circuitry is also configured to control running of the decoupled internal combustion engine.

### CROSS-REFERENCE TO RELATED APPLICATION

This application claims the benefit of and priority to German Patent Application No. 102023131088.7, filed on Nov. 9, 2023, the entire contents of which are incorporated herein by reference.

### TECHNICAL FIELD

The present disclosure relates to a method for carrying out a regeneration process of a particulate filter of a motor vehicle. Further, the present disclosure relates to an apparatus for carrying out a regeneration process of a particulate filter of a motor vehicle, to a motor vehicle, and a to computer program (product).

### BACKGROUND

Current motor vehicles are increasingly electrified with a hybrid powertrain having an internal combustion engine and at least one electric machine supporting the internal combustion engine and/or the powertrain. Typically, a particulate filter is provided to reduce the particulates present in the exhaust gas of the internal combustion engine.

In such a particulate filter, soot may accumulate over time during vehicle operation. This accumulation of soot in the particulate filter may require the particulate filter to be regenerated from time to time in a regeneration process, i.e. in a process to burn off soot in a targeted manner and thereby remove it. Such a regeneration process typically requires a sufficiently high exhaust gas temperature and a sufficiently high oxygen level to burn the soot. Accordingly, at low exhaust gas temperature, caused by low engine load, city driving, rural driving, and the like, and lack of temperature and oxygen, the soot in the particulate filter may hardly be burned. Thus, the particulate filter regeneration may be prolonged, which may mitigate the driving experience.

As emissions regulation and/or legislation become more restrictive, it may be even more difficult to achieve sufficient oxygen levels to burn off soot if, for example, lambda 1 operation of the internal combustion engine and/or for particulate filter regeneration may be specified therein. For example, the upcoming European Union regulation EU7 may require lambda 1 operation in this regard. Other emission regulations, e.g. in the US, in Asia, etc., are expected to have similar requirements.

Further, due to the support of the powertrain by the at least one electric machine, load on or of the internal combustion engine may be decreased causing low exhaust gas temperatures and reduced efficiency of the particulate filter regeneration.

### SUMMARY

Hence, there is a need to find solutions for improving particulate filter regeneration in a motor vehicle.

To this end, the present disclosure provides a method, an apparatus, a motor vehicle, and a computer program.

According to a first aspect, a method for carrying out a regeneration process of a particulate filter of a motor vehicle is provided. The method includes decoupling, in the regeneration process, an internal combustion engine from an output of a powertrain of the motor vehicle. Further, the method includes providing, at least partly timely overlapping with the decoupling of the internal combustion engine, vehicle propulsion by at least one electric machine of the motor vehicle. In addition, the method includes operating or running the decoupled internal combustion engine.

The proposed method allows for improving the regeneration of the particulate filter by decoupling and running the internal combustion engine and providing vehicle propulsion by the at least one electric machine. During its decoupling, the internal combustion engine, while running, may be used as a kind of air pump to increase the oxygen in the exhaust gas to a sufficient level. However, although the internal combustion engine is decoupled, vehicle propulsion may still be provided and/or ensured by the at least one electric machine. Further, a current or known particulate filter regeneration process requires a driver of the motor vehicle to induce and maintain a specific operating mode, i.e. overrun of the internal combustion engine, for a sufficiently long period of time. In contrast, the proposed method allows for carrying out the regeneration process at least largely or completely independent of the driver's behavior, as the internal combustion engine is decoupled and motored, and the motor vehicle still provides propulsion without noticeable overrun. In other words, the regeneration process may be carried out without any action of the driver of the motor vehicle and without the driver noticing the process. In addition, duration of the regeneration process may be reduced significantly. In other words, the oxygen required for the regeneration process may be supplied by running the de-coupled internal combustion engine, so the internal combustion engine is used as a kind of “air pump” to supply oxygen, while propulsion of the vehicle is ensured by the at least one electric machine. This may enable carrying out the regeneration process without driver interaction and/or notice.

As used herein, the particulate filter may be broadly understood as a device capable of removing particulate matter, and if applicable soot, from the exhaust gas of an internal combustion engine. For example, the particulate filter may be configured as a gasoline particulate filter (GPF) or as a diesel particulate filter (DPF). Accordingly, the internal combustion engine may be configured as an Otto engine, i.e., a gasoline Otto cycle engine, or a diesel engine. The particulate filter may be monitored by at least one particulate filter sensor, e.g. for detecting a soot level or the like of the particulate filter. Alternatively, or additionally, the particulate filter may be monitored and/or the need for the regeneration process may be determined by using a computer model, e.g. software model, configured for this purpose.

Further, as used herein, the regeneration process of the particulate filter may serve, for example, to prevent the particulate filter from becoming clogged by reducing soot remaining in the particulate filter. The regeneration process may include burning the soot to ash. For this purpose, a minimum exhaust temperature and a sufficient oxygen level in the exhaust gas may be required. For example, the minimum exhaust temperature, i.e. a threshold temperature, may be several hundred degrees Celsius, e.g. approximately 550° C. or more, depending on the particular motor vehicle. The regeneration process may be carried out on a regular basis, for example, based on the respective soot level of the particulate filter, which may be measured by a sensor or determined by computer model. By way of example, the soot level threshold may indicate, for example, that at a certain filling level, such as 70%, 80%, or the like, has been reached. For example, the regeneration process may be initiated when a certain level of soot has been accumulated within the particulate filter.

As used herein, the powertrain of the motor vehicle may include the internal combustion engine and the at least one electric machine. At the output or output side of the powertrain, the drive force of the internal combustion engine and/or the at least one electric machine may be transmitted to the road by tires. In at least some embodiments, the powertrain may further include one or more of a transmission, a differential, at least one clutch, tires, etc., arranged downstream of the internal combustion engine. Further, the motor vehicle and/or the powertrain may include at least one battery for powering the at least one electric machine. Alternatively, or additionally, the at least one electric machine may be powered by a generator coupled to the internal combustion engine. When the internal combustion engine is decoupled, it no longer provides any propulsion for the motor vehicle via the tires. For example, the decoupling of the internal combustion engine may include controlling at least one clutch of the powertrain to disengage and/or release the internal combustion engine. Likewise, coupling or re-coupling of the internal combustion engine may include controlling the at least one clutch to connect and/or engage the internal combustion engine.

The at least one electric machine may be arranged within the powertrain to provide the vehicle propulsion and/or the motoring of the decoupled combustion engine. Multiple electric machines may be arranged and/or operative at multiple different locations in the powertrain. For example, the powertrain may be a hybrid powertrain, e.g. a parallel hybrid powertrain, serial hybrid powertrain, or the like.

According to, for example, Englisch et al., (2017) “Synthesis of Various Hybrid Drive Systems”, J. Liebl, Der Antrieb von morgen 2017, such hybrid systems may be classified as P0 to P4 based on the position and/or point of interaction and/or engagement of the at least one electric machine with the internal combustion engine. The at least one electric machine as referred to herein may include one or more electric machines of the P0 to P4 classification, wherein the classification is less important than the arrangement and/or operation of the respective electrical machine. For example, in a P0 class system, the at least one electric machine may be arranged upstream of the internal combustion engine, e.g. coupled via a belt to a crankshaft of the internal combustion engine. In a P1 class system, the at least one electric machine may be firmly coupled to the crankshaft of the internal combustion engine. In a P2 class system, the at least one electric machine is arranged between the internal combustion engine and a transmission input shaft. In the P2 class system, a clutch, e.g. C0, is arranged between the internal combustion engine and the at least one electric machine and the at least one electric machine is fixedly connected or connected via a second clutch, e.g. C1, to a transmission input shaft of the motor vehicle. In a P2.5 class system, the at least one electric machine is arranged in a transmission on the input shaft of a transmission side. In a P3 class system, the at least one electric machine is firmly coupled to the transmission output shaft and the at least one electric machine is arranged between the transmission and a differential. In a P4 class system, an electric axle is formed with the at least one electric machine and a differential, or multiple electric machines as wheel hub motors. In the P4 class system, there is no mechanical coupling, e.g., shaft, to the internal combustion engine. In general, however, any electric machine that can directly or indirectly drive tires of the motor vehicle may be used for providing the vehicle propulsion during the decoupling of the internal combustion engine. The above classification for parallel hybrids is only to illustrate example arrangements of the at least one electric machine. Other arrangements are also conceivable.

In addition, as used herein, providing vehicle propulsion may be understood as keeping the motor vehicle in motion and/or setting it in motion by the at least one electric machine. In other words, the motor vehicle is actively kept or set in motion by an electric motor. For example, the at least one electric machine may be configured to provide drive force to be transmitted to the road via the tires. The vehicle propulsion may be at least approximately simultaneous with the decoupling of the internal combustion engine. For example, at the time of decoupling, the at least one electric machine may take over the vehicle propulsion from the internal combustion engine, for example for the entire duration of the decoupling or only temporarily.

Further, as used herein, the operating or running of the decoupled internal combustion engine may be understood as any operation of the combustion engine by external means. This may be accomplished, for example, by the at least one electric machine, or by any other suitable means. The internal combustion engine may be towed or in towed operation while being run. The running of the internal combustion engine may supply the oxygen required for the regeneration process, i.e. the soot burning.

The proposed method may be carried out by any computing means and may be a computer-implemented method. For example, the method may be at least partially carried out by an on-board computer of the motor vehicle. This may be, for example, at least one electronic control unit or the like. However, the method may also be at least partially carried out by a computer located remotely from the motor vehicle, such as a server, computer cloud, or the like. For example, vehicle-to-everything (V2X) may be utilized. In this case, there may be a data link between the remote computer, e.g. a V2X means, and the motor vehicle, such as a radio link or the like. For data exchange, e.g. for receiving the first data, one or more data interfaces, communication interfaces, or the like may be provided. The method may also be carried out by a distributed computer system. At least one parameter may be determined and may, for example, be stored by the motor vehicle itself or received from the remote computer. For example, at least one parameter may be stored in a suitable data source and/or may be computed in real time and/or during runtime.

It should be understood that the terms “vehicle” or “vehicular” or other similar term as used herein are inclusive of motor vehicles in general. Such motor vehicles may encompass passenger automobiles including sports utility vehicles (SUVs), buses, trucks, various commercial vehicles, and the like. Such motor vehicles may also include hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example a vehicle that is both gasoline-powered and electric-powered. Also, the vehicle may be a vehicle that is at least semi-automated, i.e. a self-driving and/or an autonomous or semi-autonomous vehicle.

According to an embodiment, the internal combustion engine may be controlled to run continuously during the regeneration process. In other words, the internal combustion engine is not turned off during the whole regeneration process. In this way, a sufficiently high exhaust temperature and sufficient supply of oxygen may be achieved.

In an embodiment, the internal combustion engine may be operated in an overrun mode while being run when de-coupled or at least part of that time. The overrun mode may include cutting off thrust by interrupting fuel supply. Overrun may facilitate the pumping of oxygen by the internal combustion engine required for soot burning.

According to an embodiment, running the internal combustion engine may include controlling at least one electric machine of the motor vehicle to run the internal combustion engine. For example, the above P0 and/or P1 class systems may be used for this purpose. However, other powertrain and/or hybrid concepts configured to run the decoupled internal combustion engine are also conceivable.

In an embodiment, the at least one electric machine may be controlled to run the internal combustion engine with a desired or certain engine speed. The engine speed may be chosen based on, for example, the oxygen required, emission regulation requirements, or the like.

According to an embodiment, the vehicle propulsion may be controlled based on a throttle pedal position. In other words, the driver may still control the vehicle by the throttle pedal or accelerator pedal, even if the regeneration process is in progress. Accordingly, the driver may still accelerate and/or decelerate the motor vehicle.

In an embodiment, the vehicle propulsion may be controlled to keep the vehicle speed at least substantially constant. In this way, the regeneration process may be hardly noticeable by the driver.

According to an embodiment, the regeneration process may be initiated based on determining that a soot level of the particulate filter exceeds a soot level threshold. For example, the soot level threshold may indicate that the particulate filter is filled with soot to a certain degree, e.g. 708, 75%, 80% or the like.

In an embodiment, the regeneration process may be initiated based on determining that an exhaust temperature of the motor vehicle exceeds a temperature threshold. For example, the temperature threshold may be several hundred degrees Celsius, such as e.g. approximately 550° C. or more.

According to an embodiment, the regeneration process may be initiated at any driving speed of the motor vehicle. The regeneration process may also be carried out during city or urban driving, rural driving, highway driving, and the like. Due to the decoupling and running of the internal combustion engine, this may be done virtually without being noticed by the driver.

In an embodiment, the regeneration process may be initiated with a cruise control of the motor vehicle activated. Due to the decoupling and running of the internal combustion engine, this may be done virtually without being noticed by the driver.

In an embodiment, in the regeneration process, the internal combustion engine may be temporarily re-coupled if an exhaust gas temperature drops below a certain threshold temperature. For example, when the exhaust gas temperature drops below the temperature threshold where soot burning is no longer possible, the internal combustion is re-coupled, and the cycle of the regeneration process repeats until the soot level has been reduced below the soot level threshold.

According to an embodiment, alternating phases of recuperation, i.e. with the internal combustion engine being coupled or re-coupled, and electrical driving, i.e. with the internal combustion engine being decoupled, may be controlled to keep the state of charge of at least one battery of the motor vehicle at a desired value and/or within a desired range.

In an embodiment, when the internal combustion engine is temporarily re-coupled, at least one electric machine of the motor vehicle is controlled to apply a load to the internal combustion engine in a recuperation mode. For example, the at least one electric machine may be controlled to apply negative torque to the internal combustion engine to increase its load and, in turn, the exhaust temperature.

According to another aspect, an apparatus for carrying out a regeneration process of a particulate filter of a motor vehicle is provided. The apparatus may also be configured for controlling the regeneration process of the particulate filter. The apparatus includes control circuitry or a controller configured to control decoupling, in the regeneration process, an internal combustion engine from an output of a powertrain of the motor vehicle. The control circuitry or controller is further configured to control providing, at least partly timely overlapping with the decoupling of the internal combustion engine, vehicle propulsion by at least one electric machine of the motor vehicle. In addition, the control circuitry or controller is configured to control running of the decoupled internal combustion engine.

For example, the apparatus may form part of and/or may be implemented by at least one electronic control module of the motor vehicle. The apparatus may include one or more of a data processor, a memory, a data interface, or the like. The apparatus may be configured to carry out the method described herein. Regarding possible embodiments of the apparatus, reference is made to the method described herein.

In an embodiment, the apparatus may further include interface circuitry or a control interface configured to receive at least one of an exhaust temperature of the motor vehicle or a soot level of the particulate filter or both. The control circuitry or controller may be further configured to initiate the regeneration process based on determining that the soot level exceeds a threshold soot level. The control circuitry or controller may also be configured to initiate the regeneration process based on determining that the exhaust temperature exceeds a threshold temperature. The control circuitry or controller may also be configured to initiate tee generation process based on either or both of these thresholds. The soot level and/or the exhaust temperature may form criteria for initiating the regeneration process. Further criteria for initiating the regeneration process may be one or more of a vehicle speed, throttle pedal position, or the like.

According to another aspect, a motor vehicle is provided. The motor vehicle includes a powertrain with a combustion engine and at least one electric machine and includes an apparatus according to the above aspect. The motor vehicle may be configured to carry out the method described herein. Regarding possible embodiments of the apparatus, reference is made to the method described herein.

According to another aspect, a computer program is provided. The computer program includes instructions which, when the program is executed by a computer, cause the computer to carry out the method of the aspect described above. The computer program may be carried out by the apparatus described herein. The computer program may be stored on a computer-readable medium, in a memory, or the like.

The technical concepts of the present disclosure are explained in greater detail with reference to various embodiments depicted in the drawings as appended. When a component, device, element, control unit, controller, or the like of the present disclosure is described as having a purpose or performing an operation, function, or the like, the component, device, element, control unit, or controller should be considered herein as being “configured to” meet that purpose or to perform that operation or function. Each component, device, element, controller, control unit, or the like may separately embody or be included with a processor and a memory, such as a non-transitory computer readable media, as part of the apparatus.

### BRIEF DESCRIPTION OF THE DRAWINGS

The accompanying drawings are included to provide a further understanding of the present disclosure and are incorporated in and constitute a part of this specification. The drawings illustrate various embodiments of the present disclosure and together with the description serve to explain the principles of the disclosure. Other embodiments of the present disclosure and many of the intended advantages of the present disclosure should be more readily appreciated as they become better understood by reference to the following detailed description. The elements of the drawings are not necessarily drawn to scale relative to each other. In the figures, like reference numerals denote like or functionally like components, unless indicated otherwise.

FIG. 1 schematically illustrates an example of a motor vehicle at which a regeneration process of a particulate filter may be carried out in accordance with an embodiment.

FIG. 2 schematically illustrates an apparatus for carrying out a regeneration process of a particulate filter of a motor vehicle according to an embodiment.

FIG. 3 illustrates a flowchart of an example of a regeneration process of a particulate filter according to an embodiment.

FIG. 4 illustrates a diagram of an example of a regeneration process for a particulate filter according to an embodiment.

FIG. 5 illustrates a flowchart of a method for carrying out a regeneration process of a particulate filter of a motor vehicle according to an embodiment.

Although specific embodiments are illustrated and described herein, it will be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

### DETAILED DESCRIPTION OF THE EMBODIMENTS

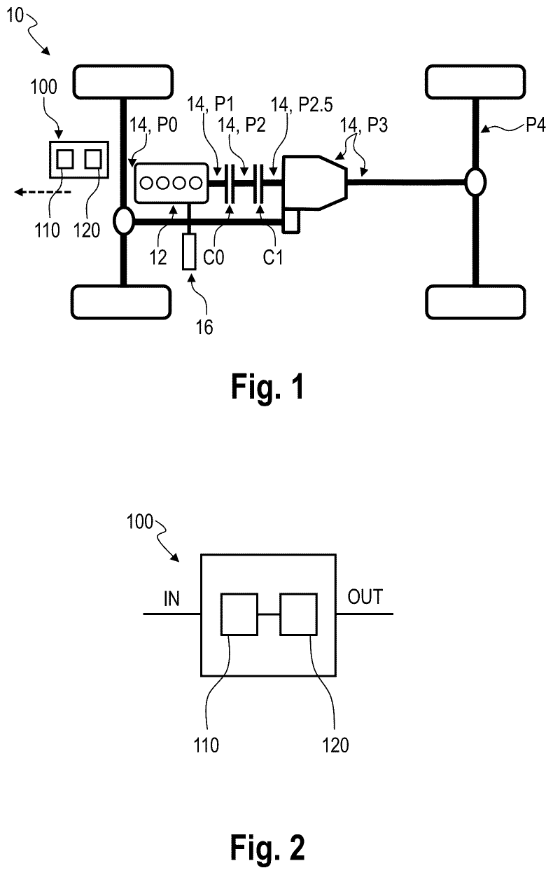

FIG. 1 illustrates schematically an example of a motor vehicle 10. A forward direction of travel of the motor vehicle 10 is to the left in FIG. 1, as indicated by a dashed arrow.

The motor vehicle 10 has a powertrain with an internal combustion engine (ICE) 12 and at least one electric machine (EM) 14. At least the ICE 12 is configured to be selectively coupled to and decoupled from an output or an output side of the powertrain, where a driving force may be transmitted to a road via tires, a transmission, a differential, and the like. Further, the motor vehicle 10 has an exhaust gas system coupled to an exhaust outlet of the ICE 12 and has a particulate filter 16. In the particulate filter 16, soot may accumulate over time and during vehicle operation. This accumulation of soot in the particulate filter 16 may require the particulate filter to be regenerated from time to time in a regeneration process. The regeneration process may be to burn off soot in a targeted manner and thereby remove it. Such a regeneration process may typically require a sufficiently high exhaust gas temperature and a sufficiently high oxygen level in the exhaust gas to burn the soot.

In addition, the motor vehicle 10 has an apparatus 100 for carrying out the above-mentioned regeneration process of the particulate filter 16.

The apparatus 100 may be part of another component such as an electronic control module of the motor vehicle 10. The apparatus 100 may have one or more of a memory for storing computer instructions, such as to implement the method described herein, a data processor, a data interface, and/or the like. The functions, operations, and/or components, i.e., circuitries of the apparatus 100 as described herein may be implemented in hardware, software, or a combination thereof.

The apparatus 100 has control circuitry 110, i.e., a controller or control unit, configured to control decoupling, in the regeneration process, of the ICE 12 from the output of the powertrain of the motor vehicle 10. Further, the control circuitry 110 is configured to control providing, at least partly timely overlapping with the decoupling of the ICE 12, vehicle propulsion by the at least one EM 14. In addition, the control circuitry 110 is configured to control motoring, i.e., running, operating, etc. of the decoupled ICE 12.

In other words, the apparatus 100 is configured to ensure, in the regeneration process, vehicle propulsion by controlling the at least one EM 14 accordingly, while the motoring of the decoupled ICE 12 allows for supplying oxygen to the exhaust gas.

Further, the apparatus 100 may include interface circuitry 120, i.e., circuits, components, a control interface, etc., coupled to the control circuitry 110 and configured to receive at least one of an exhaust temperature of the motor vehicle 10 or a soot level of the particulate filter 16. The interface circuitry 120 may be a data interface or the like configured to receive respective data or signals from, for example, a vehicle bus system or the like. The exhaust temperature and/or soot level may be derived using a respective sensor or the like.

The regeneration process of the particulate filter 16 controlled by the apparatus 100 is explained in more detail below.

Merely for better illustration of example arrangements of the at least one EM 14 within the powertrain, a P0 to P4 classification system known from literature is used herein (see the above-mentioned Englisch publication). It is noted, however, that the at least one EM 14 is not limited to these arrangements and may also be arranged and/or operative deviating therefrom, provided that the functions of the at least one EM 14 described herein may be implemented.

Accordingly, the at least one EM 14 may include one or more electric machines additionally denoted in FIG. 1 as P0, P1, P2, P2.5, P3, and P4 representing the above-mentioned classifications. This denotation mainly refers to the position and/or engagement point of the respective one of the at least one EM 14. For example, in a P0 class arrangement, the at least one EM 14, P0 may be arranged upstream of the internal combustion engine, e.g. coupled via a belt to a crankshaft of the ICE 12. In a P1 class arrangement, the at least one EM 14, P1 may be firmly coupled to the crankshaft of the ICE 12. In a P2 class arrangement, the at least one EM 14, P2 may be arranged between the internal combustion engine and a transmission input shaft. A clutch, e.g. clutch C0, may be arranged between the ICE 12 and the at least one EM 14, P2, and the at least one EM 14, P2 may be fixedly connected or connected via a second clutch, e.g. clutch C1, to a transmission input shaft of the motor vehicle 10. In a P2.5 class arrangement, the at least one EM 14, P2.5 may be arranged in a dual clutch transmission on the input shaft of a transmission side. In a P3 class arrangement, the at least one EM 14, P3 may be firmly coupled to the transmission output shaft, and the at least one EM 14, P3 may be arranged between the transmission and a differential. In a P4 class arrangement, an electric axle may be formed with the at least one EM 14, P3 and a differential, or multiple electric machines as wheel hub motors, and there is no mechanical coupling, e.g., shaft, to the ICE 12. In general, however, any electric machine that can directly or indirectly drive tires of the motor vehicle may be used for providing the vehicle propulsion during the decoupling of the internal combustion engine.

By way of example, the decoupling of the ICE 12 may include controlling, by the apparatus 100, at least one of the clutches C0, C1 to open or disengage, thereby decoupling the ICE 12 from the output of the powertrain.

Further, by way of example, at least one of the EM 14, P0 and EM 14, P1 may be used for the above-mentioned motoring of the ICE 12. In this way, the ICE 12 may be used as a kind of air pump supplying oxygen to the exhaust gas. For example, the ICE 12 may be controlled by the apparatus 100 to run continuously during the regeneration process. In other words, the ICE 12 is not turned off during the whole regeneration process. In at least some embodiments, the ICE 12 may be operated in an overrun mode during its motoring or at least part of the motoring thereof. The overrun mode may include cutting off combustion by interrupting fuel supply. Also, optionally, the ICE 12 may be motored by the EM 14, P0 and/or EM 14, P1. The EM 14, P0 and/or EM 14, P1 may be controlled to motor the internal combustion engine at a certain engine speed.

In addition, by way of example, at least one of the further EMs 14, e.g. EM 14, P2-P4 may be used to provide the above-mentioned vehicle propulsion when the ICE 12 is decoupled and therefore cannot provide vehicle propulsion. Accordingly, the apparatus 100 may be configured to control at least one of those EMs to provide or maintain the vehicle propulsion during the regeneration process. For example, the vehicle propulsion may be controlled based on a throttle or accelerator pedal position. In other words, the driver may still control the vehicle by the accelerator pedal, even if the regeneration process is in progress. Further, by way of example, the vehicle propulsion may be controlled to keep the vehicle speed at least substantially constant, i.e., maintained at a desired or constant speed, subject to normal speed variations according to expected deviation caused by the speed control method.

Further, in at least some embodiments, the regeneration process may be initiated by the apparatus 100 based on determining that a soot level of the particulate filter exceeds a certain, i.e., specified or predetermined soot level threshold. For example, the soot level threshold may indicate that the particulate filter is filled with soot to a certain degree, e.g. 70%, 75%, 80% or the like. Also, in at least some embodiments, the regeneration process may be initiated by the apparatus 100 based on determining that an exhaust temperature of the motor vehicle exceeds a certain, i.e., specified or predetermined temperature threshold. For example, the temperature threshold may be several hundred degrees Celsius, such as e.g. approximately 550° C. or more. Further, in at least some embodiments, the regeneration process may be initiated by the apparatus 100 at an at least substantially constant driving speed of the motor vehicle. For example, the driving speed may be within a speed range. The regeneration process may also be carried out during city or urban driving, rural driving, highway driving, etc. Further, in at least some embodiments, the regeneration process may be initiated by the apparatus 100 with a cruise control system or function of the motor vehicle 10 activated.

Further, in at least some embodiments, the ICE 12 may be temporarily re-coupled in the regeneration process if or when the exhaust gas temperature drops below a certain threshold temperature. For example, when the exhaust gas temperature drops below the temperature threshold where soot burning is no longer possible, the ICE 12 is re-coupled. The cycle of the regeneration process repeats until the soot level has been reduced below the soot level threshold. In addition, in at least some embodiments, the apparatus 100 may be configured to control alternating phases of recuperation, i.e. with the ICE 12 being coupled or re-coupled, and electrical driving, i.e. with the ICE 12 being decoupled, to keep the state of charge of at least one battery of the motor vehicle at a desired value and/or within a desired range. Further, in at least some embodiments, the ICE 12 may be temporarily re-coupled, and at least one EM 14 may be controlled to apply a load to the ICE 12 in a recuperation mode. For example, the at least one EM 14 may be controlled to apply negative torque to the ICE 12 to increase its load and, in turn, the exhaust temperature.

FIG. 2 schematically illustrates the apparatus 100. As described above, the apparatus 100 includes at least the control circuitry 110 configured to control at least parts of the powertrain and/or the motor vehicle 10 based on input data IN. Further, the apparatus 100 may include the above-mentioned interface circuitry 120. The apparatus 100 is further configured to generate output data OUT to be used to control at least parts of the powertrain and/or the regeneration process of the particulate filter 16.

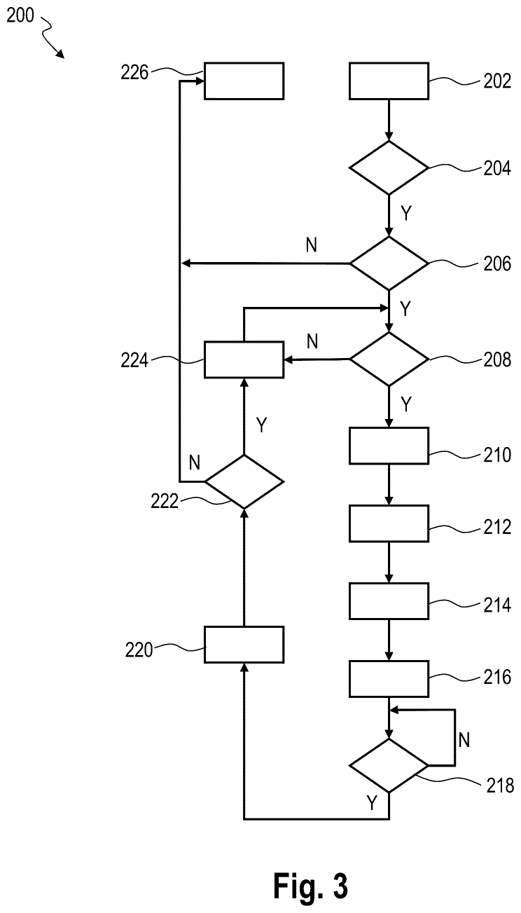

FIG. 3 illustrates a flowchart 200 of an example of the regeneration process for the particulate filter 16 described above, as it may be controlled by the apparatus 100 and/or the method described herein. It is noted that some of the blocks 202-226 are not mandatory but may be merely optional.

At Block 202, the regeneration process starts. At block 204, it may be determined whether a basic regeneration condition is met, such as whether the ICE 12 is running, a coolant temperature is sufficiently high, or the like.

At block 206, it may be determined whether the soot level is above the soot level threshold, which may be set to e.g. approximately between a minimum and a maximum soot level, load, or the like. If yes (Y), the regeneration process continues with block 208. If not (N), there is no need for regeneration of the particulate filter 16 and the regeneration process ends at block 226.

At block 208, it may be determined whether the exhaust temperature is above the exhaust temperature threshold, e.g. above approximately 550° C. or the like. If yes (Y), the regeneration process continues with block 210. If not (N), at block 224, load may be applied to the ICE 12 or increased, wherein the ICE 12 is coupled to the output of the powertrain and provides vehicle propulsion, e.g. by controlling the at least one EM 14, e.g. EM 14, P0 and/or EM 14, P1, accordingly. Also, this may be used for battery charging, i.e. charging the at least one battery of the motor vehicle 10.

After the exhaust temperature has reached or exceeded a certain level, i.e. the exhaust temperature threshold, block 208 will be left to block 210.

At block 210, the ICE 12 may be decoupled as described above, e.g. by controlling at least one clutch C1, C2 to open or disengage.

At block 212, the vehicle propulsion may be provided by the at least one EM 14, e.g. by any one EM 14, P2 to EM 14, P4 or the like, e.g. by controlling the respective EM 14 accordingly.

At block 214, the ICE 12 may be motored, e.g. by controlling e.g. the EM 14, P0 and/or EM 14, P1 accordingly.

At block 216, the soot accumulated in the particulate filter 16 is burned off.

At block 218, it may be determined whether the exhaust temperature is below the above-mentioned exhaust temperature threshold, e.g. approximately 550° C. If not (n), the soot is still burned off. If yes (Y), the regeneration process may continue at block 220.

At block 220, the ICE 12 may be coupled or re-coupled to the output of the powertrain, e.g. by controlling the at least one clutch C0, C1 accordingly.

At block 222, it may be determined whether the soot level in the particulate filter 16 is (still) above the above-mentioned soot level threshold. If not (N), there is no need for regeneration of the particulate filter 16 and the regeneration process ends at block 226. If yes (Y), the regeneration process may continue with block 224 as described above.

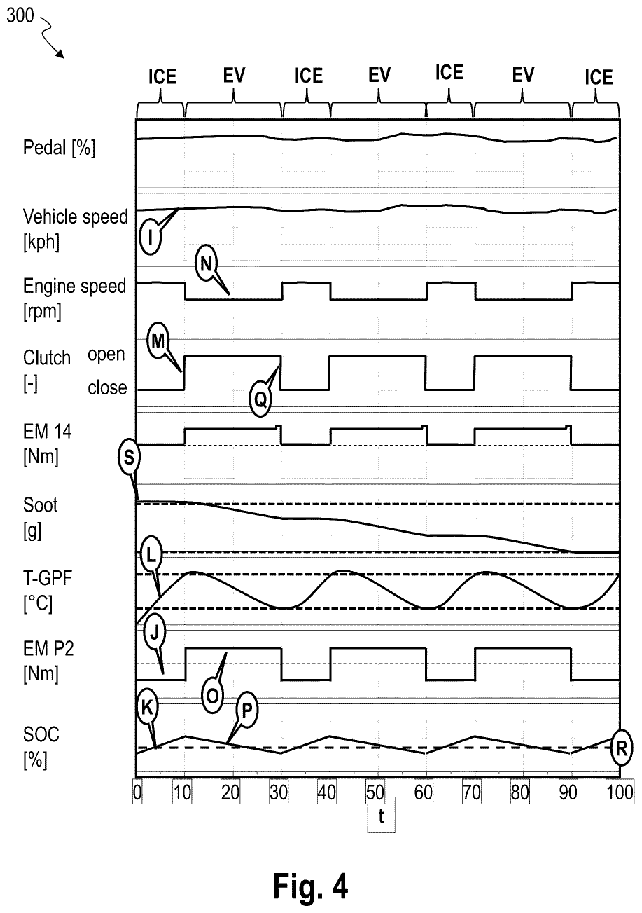

FIG. 4 illustrates a diagram 300 of an example of the regeneration process for the particulate filter 16 described above, as it may be controlled by the apparatus 100 and/or the method described herein. Diagram 300 reflects the above-described operations and/or operation blocks 202-226. In diagram 300, labels I through R denote different phases, conditions, or the like of the regeneration process. Diagram 300 illustrates, over time t; the accelerator pedal position; the vehicle speed of motor vehicle 10 in kph; the engine speed of the ICE 12 in revolutions per minute (rpm); the engaged or disengaged state of the at least one clutch; activity of, for example, the EM 14, P0 in Newton/Meters (Nm); the soot level in grams (g); the exhaust and/or particulate filter temperature T-GPF in ° C.; activity of, for example, the EM 14, P2 in Nm; and the state of charge (SOC) of the at least one battery in percentage (%). Several columns are labeled ICE and EV, respectively, to indicate whether the motor vehicle 10 is in an ICE move with vehicle propulsion by means of the ICE 12 or in an EV move with vehicle propulsion by means of the at least one EM 14.

Label I indicates that the motor vehicle 10 may travel in the ICE mode at least a substantially constant vehicle speed. Label J indicates that, for example, the EM 14, P2 may apply load to the ICE 12, such as by applying negative torque to the ICE, to increase the engine load for increasing the exhaust temperature (see label L) and/or for charging the at least one battery and/or the SOC (see label K). Label M indicates that, when the exhaust temperature exceeds a certain threshold, e.g. approximately 550° C., 630° C., or the like, the at least one clutch may be controlled to open or disengage to decouple the ICE 12 from the output of the powertrain. Label N indicates that the at least one EM 14, for example P0, may be controlled to motor or run the ICE 12 to supply oxygen for soot burning. Label O indicates that the vehicle propulsion may be provided by the at least one EM 14, for example EM 14, P2 or any other suitable EM 14 P2-P4. As can be seen in FIG. 4, the vehicle speed may be maintained at least substantially constant. It should be noted that, in order to gain sufficient exhaust temperature and supply of oxygen, the ICE 12 is not turned off during the whole regeneration process. Further, the ICE 12 may be toggled between fired operation, e.g. at Lambda 1, and the decoupled and/or motored mode. As indicated by label P, the SOC of the at least one battery may decrease during the EV mode. When the exhaust gas temperature drops below the temperature where soot burning is no longer possible, the clutch engages again as indicated by label Q, and the cycle repeats until the soot level has been decreased below the soot level threshold. Controlling alternating phases of recuperation and electrical driving may keep the electrical charge almost neutral as indicated by label R.

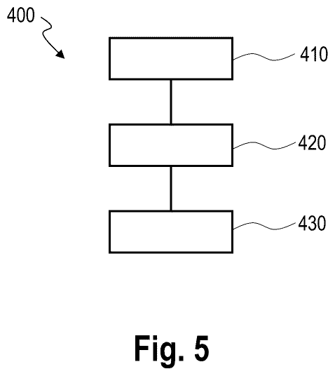

FIG. 5 illustrates a flowchart of an example of a method 400 for carrying out a regeneration process of a particulate filter, e.g. particulate filter 16, of a motor vehicle, e.g. motor vehicle 10. The method 400 may be carried out by the motor vehicle 10 and/or the apparatus 100.

The method 400 includes decoupling 410, in the regeneration process, an internal combustion engine, e.g. ICE 12, from an output of a powertrain of the motor vehicle. Further, the method 400 includes providing 420, at least partly timely overlapping with the decoupling of the internal combustion engine, vehicle propulsion by at least one electric machine of the motor vehicle, e.g. EM 14. In addition, the method includes 430 motoring the decoupled internal combustion engine.

It should be noted that the method 400 may be combined with the features described herein with reference to the further aspects, such as the apparatus 100.

In the foregoing detailed description, various features are grouped together in one or more examples with the purpose of streamlining the disclosure. It is to be understood that the above description is intended to be illustrative, and not restrictive. It is intended to cover all alternatives, modifications, and equivalents of the different features and embodiments. Many other examples should be apparent to one of ordinary skill in the art upon reviewing the above specification. The embodiments were chosen and described in order to explain the principles of the disclosure and its practical applications, to thereby enable others having ordinary skill in the art to utilize the inventive concepts and various embodiments with various modifications as are suited to the particular use contemplated.

### REFERENCE LIST

10 motor vehicle
12 internal combustion engine
14 electric machine(s)
16 particulate filter
100 apparatus
110 control circuitry
120 interface circuitry
200 flowchart
202-226 operation block(s)
300 diagram
I-R labels
400 method
410-430 method step(s)

What is claimed is:

1. A method for carrying out a regeneration process of a particulate filter of a motor vehicle, the method comprising:
decoupling, in the regeneration process, an internal combustion engine from an output of a powertrain of the motor vehicle;
providing, at least partly timely overlapping with the decoupling of the internal combustion engine, vehicle propulsion by at least one electric machine of the motor vehicle; and
running the decoupled internal combustion engine.

2. The method of claim 1, wherein the internal combustion engine is controlled to run continuously during the regeneration process.

3. The method of claim 1, wherein the internal combustion engine is controlled to run in an overrun mode when running while decoupled.

4. The method of claim 1, wherein running the internal combustion engine comprises controlling at least one electric machine of the motor vehicle to run the internal combustion engine.

5. The method of claim 4, wherein the at least one electric machine is controlled to motor the internal combustion engine with a certain engine speed.

6. The method of claim 1, wherein the vehicle propulsion is controlled based on an accelerator pedal position.

7. The method of claim 1, wherein the vehicle propulsion is controlled to keep the vehicle speed at least substantially constant.

8. The method of claim 1, wherein the regeneration process is initiated based on determining that a soot level of the particulate filter exceeds a threshold soot level.

9. The method of claim 1, wherein the regeneration process is initiated based on determining that an exhaust temperature of the motor vehicle exceeds a threshold temperature.

10. The method of claim 1, wherein the regeneration process is initiated at at least a predetermined driving speed of the motor vehicle.

11. The method of claim 10, wherein the regeneration process is initiated with a cruise control of the motor vehicle activated.

12. The method of claim 1, wherein, in the regeneration process, the internal combustion engine (is temporarily re-coupled if an exhaust gas temperature drops below a threshold temperature.

13. The method of claim 12, wherein, when the internal combustion engine is temporarily re-coupled, at least one electric machine of the motor vehicle is controlled to apply a load to the internal combustion engine in a recuperation mode.

14. An apparatus for carrying out a regeneration process of a particulate filter of a motor vehicle, the apparatus comprising control circuitry configured to:
control decoupling, in the regeneration process, an internal combustion engine from an output of a powertrain of the motor vehicle;
control providing, at least partly timely overlapping with the decoupling of the internal combustion engine, vehicle propulsion by at least one electric machine of the motor vehicle; and
control running of the decoupled internal combustion engine.

15. The apparatus of claim 14, further comprising:
interface circuitry configured to receive at least one of an exhaust temperature of the motor vehicle or a soot level of the particulate filter, or both,
wherein the control circuitry is further configured to
initiate the regeneration process based on determining that the soot level exceeds a threshold soot level, and/or
initiate the regeneration process based on determining that the exhaust temperature exceeds a threshold temperature.

16. A motor vehicle comprising:
the powertrain with the combustion engine and the at least one electric machine; and
at least one apparatus according to claim 14.

17. A computer program comprising instructions which, when the program is executed by a computer, cause the computer to carry out the method of claim 1.
